(19) United States
(12) Patent Application Publication
(10) Pub. No.: US 2025/0280852 A1
(43) Pub. Date: Sep. 11, 2025

(54) BONE BROTH-BASED FOOD PRODUCTS AND PROCESSES FOR MAKING THE SAME

(71) Applicant: Daniel Eisenman, Boulder, CO (US)

(72) Inventor: Daniel Eisenman, Boulder, CO (US)

(21) Appl. No.: 19/059,225

(22) Filed: Feb. 20, 2025

Related U.S. Application Data
(60) Provisional application No. 63/556,867, filed on Feb. 22, 2024.

(51) Int. Cl. A23J 3/04; A23B 2/92; A23L 5/10; A23L 23/10

(52) U.S. Cl. CPC A23J 3/04; A23B 2/92; A23L 5/13; A23L 23/10

(57) ABSTRACT

A method of producing a food product from bone broth for nutritional and culinary applications. The method includes boiling vertebrate animal bones without pressure and for an amount of time, and under conditions, sufficient to yield a bone broth. The method includes freeze-drying the bone broth for an amount of time, and under conditions, sufficient to yield a crystallized food product. The food product may be in the form of chips, powder, or granules. The method yielding the food product preserves the nutritional integrity of the ingredients, offering a convenient, versatile, and healthful addition to the consumer's diet.

### CROSS-REFERENCE TO RELATED APPLICATIONS

The application claims the benefit of and priority to U.S. Provisional Patent Application No. 63/556,867 filed on Feb. 22, 2024, which is incorporated herein by reference in its entirety.

### FIELD OF THE INVENTION

The present invention relates to the field of nutritional food products, specifically to a method and product line involving the crystallization of collagen, marrow, and bone broth for culinary and health applications.

### BACKGROUND

The health food industry has seen growing interest in collagen products due to their benefits for skin, joint health, and overall wellness. However, the market lacks innovative, versatile, and convenient collagen-based products that cater to both health benefits and culinary uses.

Accordingly, a need exists for technology that overcomes the problems demonstrated above, as well as one that provides additional benefits. The examples provided herein of some prior or related devices, systems, methods, materials or compositions of matter, and their associated limitations, are intended to be illustrative and not exclusive. Other limitations of existing or prior products and associated methods will become apparent to those of skill in the art upon reading the following detailed description.

### SUMMARY

The invention provides a unique method of processing collagen, marrow, and bone broth into a crystallized form, suitable for a variety of culinary and health applications. The product line includes Sticks & Bones, FemurCreamer, and Tallow, wherein each may be crafted from, for example and without limitation, 100% grass-fed, grass-finished bones. The crystallization process preserves the nutritional integrity of the ingredients, offering a convenient, versatile, and healthful addition to the consumer's dict.

A first aspect of the disclosure provides a method or process of producing a food product including crystallized collagen, marrow, and bone broth for nutritional and culinary applications. The method may include the step of boiling vertebrate animal bones without pressure and for an amount of time, and under conditions, sufficient to yield a bone broth. The method may also include the step of freeze-drying the bone broth for an amount of time, and under conditions, sufficient to yield a crystallized food product.

In one embodiment, the method according to the first aspect of the disclosure may also include the step of removing the crystallized food product from one or more freeze-dryer trays used for the freeze-drying step. The removing step of the method may be performed after the freeze-drying step. In an example, the removing step may include breaking the crystallized food product from the one or more freeze-dryer trays to yield chips. In another example, the freeze-drying step of the method may yield the crystallized food product in the aforementioned chip form.

In some embodiments, the method according to the first aspect may include the step of converting the chips into a powder or granulated form. In some embodiments, the method according to the first aspect may include the step of transferring the bone broth to a freeze-dryer tray. In an example, the transferring step of the method may be performed after the boiling step and before the freeze-drying step. In an example, the transferring step of the method may include filling the freeze-dryer to its full volumetric capacity. A depth of the freeze-dryer tray may be three-quarters of an inch. After the freeze-drying step, a thickness of the crystallized food product may be a half an inch. In an example, the freeze-drying step may yield the crystallized food product having a thickness that is less than the depth of the freeze-dryer tray. The depth of the freeze-dryer tray and the resulting thickness of the crystallized food product may vary according to the particular freeze-dryer system being used to practice the present technology.

In one embodiment, the method according to the first aspect may include the step of roasting the vertebrate animal bones before the boiling step. In an example, the method may include the step of recovering animal fat from the vertebrate animal bones during the roasting step. In such embodiments, the method may also include the step of processing the recovered animal fat to yield a tallow, lard, or suet product. In another example, the method may further include the step of adding at least one flavoring material to the vertebrate animal bones before, during, or after the roasting step.

In some embodiments, the method according to the first aspect may include the step of removing residual tissues from the vertebrate animal bones prior to the boiling step. In one embodiment, the method according to the first aspect may include the step of adding at least one flavoring material to the vertebrate animal bones before, during, or after the boiling step. In one embodiment, the boiling step may of the method may include slow simmering the vertebrate animal bones. In some embodiments, the boiling step of the method may include boiling the vertebrate animal bones in spring water.

In one embodiment, the method according to the first aspect may include the step of refrigerating the bone broth for an amount of time, and at a temperature, sufficient to separate animal fat to a layer on top of the bone broth. Refrigerating the bone broth may turn the bone broth into a gelatin or gelatin-like form. For this embodiment of the method, refrigerating the bone broth may be performed after the boiling step and before the freeze-drying step. In an example, the method may include the step of recovering the animal fat from the layer on top of the bone broth during or after the refrigerating step. In this example, the method may further include the step of processing the recovered animal fat to yield a tallow, lard, or suet product. The vertebrate animal bones may be removed from the bone broth after the boiling step and before the refrigerating step.

In some embodiments, the method according to the first aspect may include the step of blending the bone broth after the boiling step and before the freeze-drying step. In an example, the blending step of the method may include blending the bone broth for an amount of time, and under conditions (e.g., temperature, blending speed, and the like), sufficient to convert the bone broth to a froth. The temperature of the bone broth may be adjusted or maintained before or during the blending step of the method.

In one embodiment, the method according to the first aspect may include the step of providing the vertebrate animal bones from a plurality of animal species for the boiling step. In other embodiments, vertebrate bones may be so provided from just a single species of animal. In some embodiments, only one type of bone (e.g., just femur bones) may be provided for the boiling step of the method. In some embodiments, the method according to the first aspect may include the step of packaging the crystallized food product (e.g., as chips, powder, or granules) in a bag, a jar, or other suitable container.

A second aspect of the disclosure provides a food product. The food product according to the second aspect may be produced using the method or process according to the first aspect of the disclosure. In some embodiments, the food product according to the second aspect may be in the form of chips. In other embodiments, the food product according to the second aspect may be in the form of powder or granules. In an example, the food product in the form of powder or granules may be suitable for use as a creamer product. The food product according to the second aspect of the disclosure may be suitable for consumption by humans or pets (e.g., dogs and cats).

While multiple embodiments are disclosed, still other embodiments of the present technology will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings.

FIG. 1 depicts a flow chart of a method of producing a food product including crystallized collagen, marrow, and bone broth for nutritional and culinary applications, according to the some embodiments of the present technology.

FIG. 2 depicts a top view of a food product in the form of a chip produced using the method depicted in FIG. 1, according to some embodiments of the present technology.

FIG. 3 depicts a perspective view of the food product shown in FIG. 2, according to some embodiments of the present technology.

FIG. 4 depicts a food product in a powder form produced using the method depicted in FIG. 1, according to some embodiments of the present technology.

FIG. 5 depicts a packaged food product in a granulated form produced using the method depicted in FIG. 1, according to some embodiments of the present technology.

The drawings have not necessarily been drawn to scale. Similarly, some components and/or operations may be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as disclosed and/or claimed herein.

### DETAILED DESCRIPTION

The invention addresses gaps in the health foods products market by providing innovative, versatile, and convenient collagen-based products that cater to both health benefits and culinary uses. The technical and commercial value of the bone broth-based food products and processes for making the same as described herein introduces a novel method of crystallizing collagen and related materials yielding a useful and valuable product line that combines nutritional benefits with culinary versatility.

### 1. Sourcing of Raw Materials

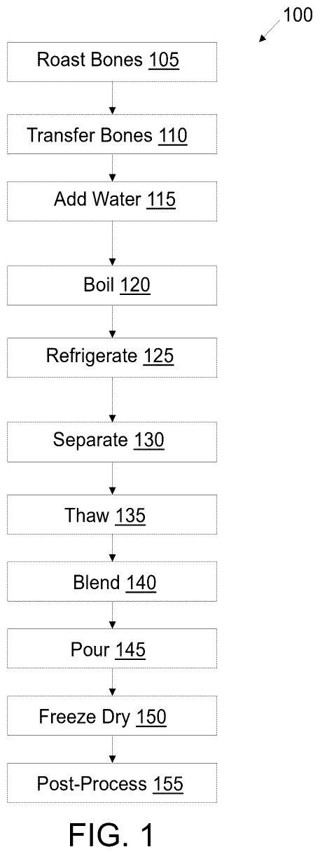

The invention may use bones sourced from 100% grass-fed, grass-finished bison, venison, and/or grass-finished beef, locally sourced in the USA, prioritizing ethical and sustainable farming practices. A variety of other sources of bones may be utilized in the process, as discussed below with reference to FIG. 1.

### 2. Production Process

In some embodiments, the vertebrate bones may be subjected to a slow simmering process without pressure, using spring water to extract collagen, marrow, and bone broth. The broth may then be freeze-dried, a key step in the crystallization process that differentiates the product from competitors. This method ensures the preservation of nutrients and extends the shelf life of the products. In some embodiments, the freeze-dryer trays utilized in practice of the present technology may have a depth of three quarters of an inch. The depth of the freeze-dryer tray and the resulting thickness of the crystallized food product after freeze drying may vary according to the particular freeze-dryer system being used to practice the present technology.

The following narrative describes an example of a production process 100 for a bone broth-based food product according to some embodiments of the disclosure, as shown in FIG. 1.
A. A suitable amount of animal bones (specifically of vertebrates, to include animals having cartilaginous skeletons like sharks and rays) may be roasted (step 105 in FIG. 1). For example, and without limitation, a suitable mass of 100% grass fed bison bones may be roasted at 400 degrees Fahrenheit in an oven for 1 hour. In other examples, the bones may be from cattle, elk, deer, lamb, sheep, goat, horse, yak, llama, game, poultry, birds generally, salmon, and fish generally, any combination of those. In yet another example, the bones may be a combination of two or more of bison, cattle, deer and elk bones. In still another example, at least a portion of the bones to be roasted may have residual tissues (e.g., fat, muscle, tendon, organs, etc.) attached to them. In yet another example, at least a portion of the bones to be roasted may have such residual tissues removed from them, either before, during, or after commencement of the roasting step of the disclosed method. In some embodiments, only the bones without any of the sort of attached residual tissues may be subjected to the roasting 105 in the process 100. In an example, fat removed from the bones during roasting may be recovered to produce tallow, lard, suet, and the like for use in further processing.

In some embodiments, roasting 105 of the bones may be an optional step in process 100—that is, process 100 may commence with step 110 without including the roasting 105 step. In such embodiments, the bones may be used in step 110 described below, either with or without any residual tissues attached to them. In some examples, performance of the roasting 105 step in process 100 may result in enhanced or otherwise different flavor profiles in a final food product yield by method 100.
B. The bones (whether roasted 105 or not) may be transferred (step 110 in FIG. 1) to a suitable vessel (e.g., stainless steel pot having a volume sufficient to contain the roasted bones). In one embodiment, 65 pounds of roasted 100% grass fed bison bones from A may be transferred to the vessel. Additionally, herbs or other materials (e.g., salt) for flavoring (e.g, rosemary/sea salt, dill/mustard, etc.) can be added to the vessel before, after or at least partially concurrent with, step 105. Alternatively, or in addition to, being added at or around the time of starting step 105 in method 100, the same and/or other herbs or other materials may be added carlier (e.g., during roasting 105) or later (e.g., during the boiling 120 and/or refrigerating 125 step(s)) in method 100. Such materials like herbs, salt, etc. may be collectively referred to herein as “flavoring materials.”
C. A sufficient volume water may be added (step 115 in FIG. 1) to the vessel to cover the bones. In an example, additional water may be added to the vessel beyond the amount sufficient to cover the bones. This additional volume of water may be added to allow for loss of volume of the water due to such effects as water being absorbed into the bones and/or water evaporating or boiling off as steam during the boiling as described below in D. In another example, the water added to the vessel may be spring water.
D. The water in the vessel containing the bones may be boiled (step 120 in FIG. 1). In an example, 65 pounds of 100% GrassFed Bison bones from A above may be boiled for 24 hours in 11 gallons of spring water. More particularly, this boiling step may be a slow simmering. In one embodiment, the bones may be added to water in the vessel that is already boiling. In another embodiment, the bones may be added to non-boiling water before the water is brought to a boil.
E. After the boiling 120 step, the resulting broth may be refrigerated (step 125 in FIG. 1). In an example, the broth may be refrigerated broth at 38 to 42 degrees Fahrenheit for 24 hours or until all the fat/tallow is separated on the top. In another example, the broth may be refrigerated at a temperature, and for an amount of time, sufficient to separate the fat/tallow into a layer on the top of the broth.

In some embodiments, the boiled 125 bones may be removed from the broth prior to or at least partially concurrent with, the commencement of the refrigerating 125 in method 100. In an example, removing the bones from the broth may be accomplished by physically removing the bones from the vessel used for the boiling 120. For instance, a manual, yet sanitary technique using utensils such as tongs may be utilized for this purposes. In another example, removing the bones from the broth may be accomplished by pouring the broth from a first vessel (e.g., the vessel using for boiling 120 the bones) into a second such vessel without also transferred the bones. For instance, the second vessel may have a strainer, screen, filter or similar device (or combinations of the same) placed over its top opening such that the liquid broth may be poured from the first to the second vessel with any bones or bone pieces or other non-liquid material may be trapped in the aforementioned device(s) and the broth liquid allowed to pass into the second vessel.
F. After the refrigerating 125 step, the fat/tallow may be separated (step 130 in FIG. 1) from the top of the broth. The separated tallow may be used for a tallow balm in some embodiments. Basically, all the fat raises to the top once cooled for those 24 hours, and then it can be skimmed off the broth to remove it. A variety of techniques may be used for the separating 130 step in process 100. In an example, a skimmer may be used to remove the fat/tallow from the top. In another example, the vessel containing the broth during the separating 130 step may have a faucet or other valve-like device at or near its bottom. In such examples, the broth may be dispensed from that first vessel to another vessel by dispensing the broth from the first vessel to the another vessel by way of the faucet or like device.
G. After the separating 130 step, the broth may be in the form of a gelatin, where the formation of the gelatin may be accelerated by the refrigerating 125 step. As such, the broth may be thawed (step 135 in FIG. 1). In some embodiments, the broth may be thawed 135 by heating it at a temperature, and for a time, sufficient to make the gelatin a liquid.
H. After, or at least partially concurrent with, the thawing 135 step, the broth may be blended (step 140 in FIG. 1). In some embodiments, the broth may be blended 140 for about 20 seconds (e.g., for 15-25 seconds). In other embodiments, the broth may be blended 140 for a time, and at a temperature, sufficient to allow the broth to be blended 140. In an example, the broth may be blended 140 to a froth. Blending 140 the broth to a froth may be desired in cases where the broth has a high fat content. Frothing the broth in this way may include blending 140 for longer than about 20 seconds (e.g., for 25-40, or more, seconds).

In some embodiments, blending 140 may be performed in method 100 at a predetermined temperature. For instance, the thawing 135 may be performed by raising the broth to a first temperature, and then the blending 140 may be performed at a temperature that is approximately equal to the first temperature (e.g., within 5 degrees Fahrenheit). In another example, blending 140 may be performed at a different temperature as compared to the first temperature at which the thawing 135 is performed. That second different temperature for the blending 140 step may be either greater than or less than the first temperature for the thawing 135 step.

As described in “K” below, a final product of the method 100 may be in the form of chips. A texture, density and/or thickness of such chips may vary with variations in times for, and temperatures at which, the blending 140 is performed, as well as an extent to which the broth is blended 140 to a froth. In a first example use case, chips produced from freeze drying 150 a blended 140, but not frothed, broth may be thin crisps. In a second example use case, the food product produced from freeze drying 150 the broth that was blended 140 to a froth may yield a thicker and/or puffier food product as compared to the first example use case, where the chip may be more like a wafer. The thickness of the chips may also vary according to a depth of freeze dryer tray(s) used in method 100, as further described below in K.
I. After the blending 140 step, the blended broth may be poured (step 145 in FIG. 1) into a freeze drying tray. The freeze drying tray may have a size and/or a volume sufficient to contain the entire volume of poured 145 frothy broth to a depth sufficient for freeze drying, as described below in J. In an example, the broth may be poured 145 into multiple freeze drying trays. In some embodiments, the broth may be poured 145 to fill each freeze dryer tray to maximum capacity. In the case of pouring 145 a broth that had been blended 140 to a froth, the freeze drying tray may be first brought to a temperature of, for example and without limitation, less than or equal to 32 degrees Fahrenheit. As such, the pouring 145 may be performed in process 100 in a cold room environment in some cases.
J. After the pouring 145 step, the frothed/blended broth in the freeze dryer tray may be freeze dried (step 150 in FIG. 1) in a freeze drier. The freeze drying 150 step may be performed under conditions, and for a time, sufficient to fully dry the frothed/blended broth in the freeze drier tray. In an example, an automated commercial freeze drier may be utilized for the freeze drying 150 step in method 100, where the system may determine that the broth is fully dried (e.g., by way of a sensor such as a hygrometer). Freeze drying 150 may be performed for an amount of time and under conditions (e.g., temperature and pressure) sufficient to form the crystallized food product. In some embodiments, the freeze drying 150 may be performed for approximately 70 hours (e.g., 65-75 hours).
K. After the freeze drying 150 step, the freeze dried broth may be post-processed (step 155 in FIG. 1). In an example, the freeze dried broth in the freeze drier tray may be in chip format. In some embodiments, the post-processing 155 may include removing the freeze dried product from the freeze drier tray and at least one of breaking the chips to a desired size (or sizes), and turning the chips into a powder (e.g., FemurCreamer crystallized bone broth powder) or granules. The resulting food product may be suitable for nutritious, tasty, and healthy consumption by both humans or animal pets (e.g., dogs and cats).

### 3. Product Line Examples

STICKS & BONES: Single serving crystallized collagen, marrow, and bone broth chip, suitable for eating and/or dissolving in hot beverages.

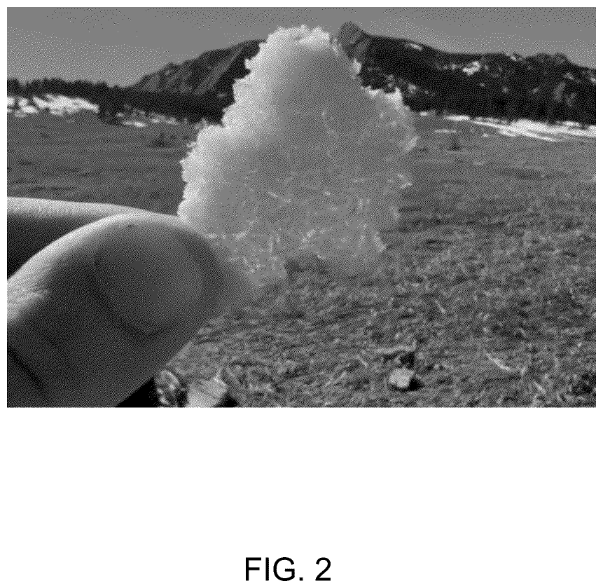

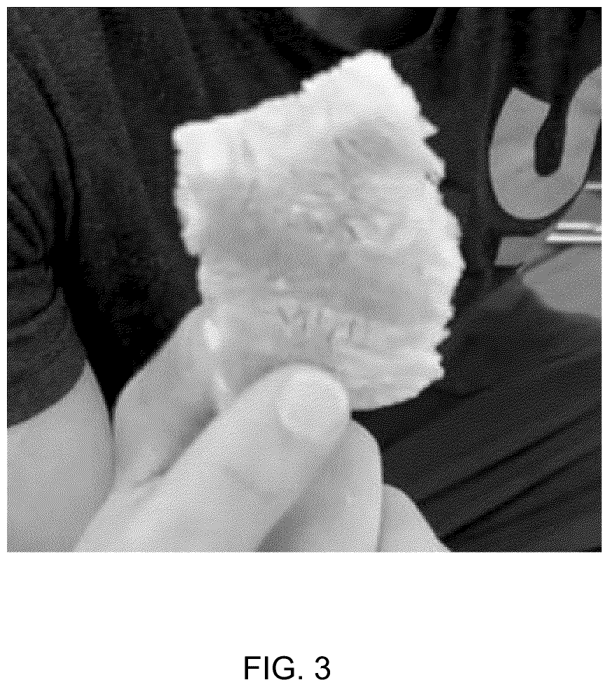

FIG. 2 depicts a top view of a food product in the form of a chip produced using the method 100 depicted in FIG. 1, according to some embodiments of the present technology. FIG. 3 depicts a perspective view of the food product shown in FIG. 2, according to some embodiments of the present technology.

FEMURCREAMER: Dairy-free creamer alternative made from crystallized collagen, marrow, and bone broth, designed to enhance beverages.

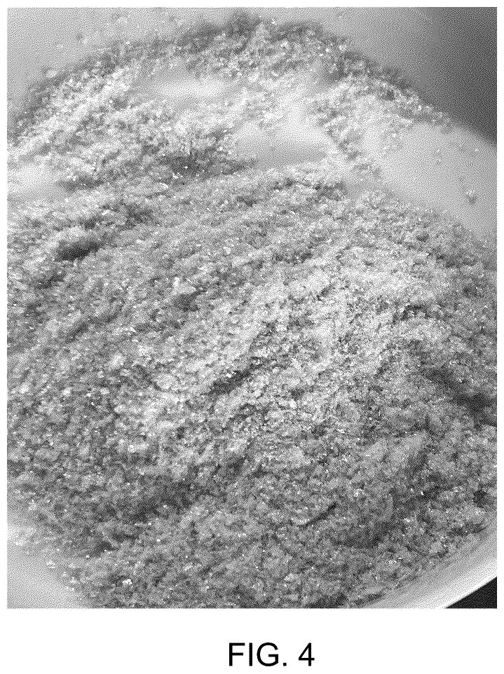

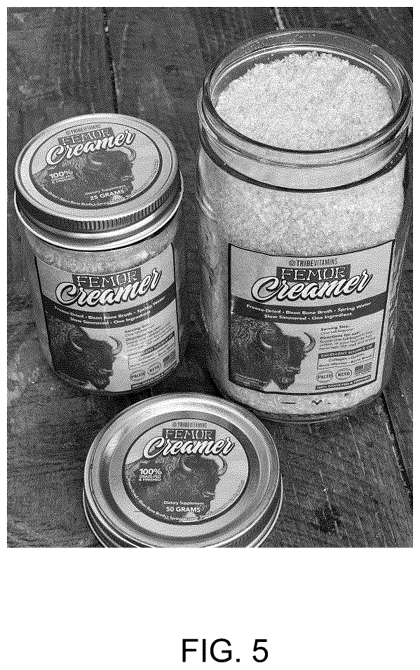

FIG. 4 depicts a food product in a powder form produced using the method 100 depicted in FIG. 1, according to some embodiments of the present technology. FIG. 5 depicts a packaged food product in a granulated form produced using the method 100 depicted in FIG. 1, according to some embodiments of the present technology.

Tallow: A byproduct of the production process, utilized for culinary and skincare applications.

### 4. Unique Value Proposition

The invention's unique selling proposition lies in its innovative approach to collagen utilization, offering products that not only cater to health-conscious consumers but also provide culinary versatility. The crystallized form factor, combined with the nutritional benefits of grass-fed bone sources, sets the invention apart in the market. At least some known processes use “spray drying” rather than freeze drying.

### Conclusion

The present disclosure outlines the innovative approach of BoneAir in creating a new category of collagen-based products that offer both health benefits and culinary versatility. The detailed description of the invention describes the several unique aspects of the product line and manufacturing process.

The illustrations of the embodiments described herein are intended to provide a general understanding of the structure and/or process relating to the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments can be made, and other embodiments not specifically described herein will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

1. A method of producing a food product from bone broth for nutritional and culinary applications, the method comprising:
boiling vertebrate animal bones without pressure and for an amount of time, and under conditions, sufficient to yield a bone broth;
blending the bone broth; and
after the blending step, freeze-drying the bone broth for an amount of time, and under conditions, sufficient to yield a crystallized food product.

2. The method of claim 1 further comprising, after the freeze-drying step, removing the crystallized food product from one or more freeze-dryer trays used for the freeze-drying step.

3. The method of claim 2, wherein the removing step comprises breaking the crystallized food product from the one or more freeze-dryer trays to yield chips.

4. The method of claim 2 further comprising converting the crystallized food product into a powder or granulated form.

5. The method of claim 1 further comprising, after the boiling step and before the freeze-drying step of the method, transferring the bone broth to at least one freeze-dryer tray.

6. The method of claim 5, wherein the transferring step comprises filling the at least one freeze-dryer tray to its full volumetric capacity.

7-8. (canceled)

9. The method of claim 6, wherein the freeze-drying step yields the crystallized food product having a thickness that is less than a depth of the freeze-dryer tray.

10. The method of claim 1 further comprising roasting the vertebrate animal bones before the boiling step.

11. The method of claim 10 further comprising recovering animal fat from the vertebrate animal bones during the roasting step.

12-13. (canceled)

14. The method of claim 1 further comprising removing residual tissues from the vertebrate animal bones prior to the boiling step.

15. The method of claim 1 further comprising adding at least one flavoring material to the vertebrate animal bones before, during, or after the boiling step.

16. The method of claim 1, wherein the boiling step comprises slow simmering the vertebrate animal bones.

17. (canceled)

18. The method of claim 1 further comprising, after the boiling step and before the freeze-drying step, refrigerating the bone broth for an amount of time, and at a temperature, sufficient to separate animal fat to a layer on top of the bone broth.

19. The method of claim 18 further comprising recovering the animal fat from the layer on top of the bone broth during or after the refrigerating step.

20. (canceled)

21. The method of claim 18 further comprising removing the vertebrate animal bones from the bone broth after the boiling step and before the refrigerating step.

22. (canceled)

23. The method of claim 1, wherein the blending step comprises blending the bone broth for an amount of time, and under conditions, sufficient to convert the bone broth to a froth.

24-25. (canceled)

26. A food product manufactured, at least in part, by the method of claim 1.

27. The food product of claim 26, wherein the food product is in the form of:
chips, powder, or granules.

28. A method of producing a food product from bone broth for nutritional and culinary applications, the method comprising:
boiling vertebrate animal bones without pressure and for an amount of time, and under conditions, sufficient to yield a bone broth;
blending the bone broth for an amount of time, and under conditions. sufficient to convert the bone broth to a froth; and
after the blending step, freeze-drying the bone broth for an amount of time, and under conditions, sufficient to yield a crystallized food product.

29. (canceled)

30. A food product manufactured, at least in part, by the method of claim 28.
